(19) United States
(12) Patent Application Publication
(10) Pub. No.: US 2026/0259420 A1
(43) Pub. Date: Sep. 3, 2026

(54) MICROSCOPE-BASED SYSTEM AND METHOD USING A UV-TRANSMISSIBLE MIRROR

(71) Applicants: Jung-Chi LIAO, Taipei City (CN); SYNCELL (TAIWAN) INC., Taipei City (TW)

(72) Inventors: Yi-De CHEN, Taipei (TW); Jung-Chi LIAO, Taipei City (TW)

(21) Appl. No.: 18/877,609

(22) PCT Filed: Jun. 23, 2023
(86) PCT No.: PCT/US2023/068962

§ 371 Date: Dec. 20, 2024

Related U.S. Application Data
(60) Provisional application No. 63/354,806, filed on Jun. 23, 2022.
(60) Provisional application No. 63/509,485, filed on Jun. 21, 2023.

(51) Int. Cl. G02B 27/14; G01N 21/64; G02B 21/06; G02B 21/16

(52) U.S. Cl. CPC G02B 27/141; G01N 21/64; G02B 21/06; G02B 21/16; G01N 2201/0636

(57) ABSTRACT

A microscope-based system and a method for image-guided microscopic illumination are provided. The microscope comprises a stage, and the stage is configured to be loaded with a sample. The microscope-based system includes a first light source, a second light source, a first dichroic mirror, a second dichroic mirror, and a receiver. The first and second dichroic mirrors are highly transmissive in transmissive wavelength bands and highly reflective in reflective wavelength bands to selectively transmit/receive light from the first light sources to the sample and to the receiver for imaging samples, and allow transmit light from the second light source to the sample for photochemical processing at specific locations (pattern illumination) according to the imaging. The characteristic design of the two dichroic mirror systems allows multi-channel (wavelength) imaging and patten illumination can be operated quickly without using mechanical switches for switching different light path for each individual function.

### CROSS REFERENCE TO RELATED APPLICATIONS

This application claims the benefit of U.S. Provisional Application No. 63/354,806, filed Jun. 23, 2022, entitled “MICROSCOPE-BASED SYSTEM AND METHOD USING A UV-TRANSMISSIBLE MIRROR”, and U.S. Provisional Application No. 63/509,485, filed Jun. 21, 2023, entitled “MICROSCOPE-BASED SYSTEM AND METHOD USING A UV-TRANSMISSIBLE MIRROR”, which are both incorporated herein by reference in their entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### BACKGROUND

The present disclosure relates to a system and method for illuminating patterns on a sample, especially relating to a microscope-based system and method for illuminating varying patterns through a large number of fields of view consecutively at a high speed.

There are needs in illuminating patterns on samples (e.g., biological samples) at specific locations. Processes such as photobleaching of molecules at certain subcellular areas, photoactivation of fluorophores at a confined location, optogenetics, light-triggered release of reactive oxygen species within a designated organelle, or photoinduced labeling of biomolecules in a defined structure feature of a cell all require pattern illumination. For certain applications, the pattern of the abovementioned processes may need to be determined by a microscopic image. Some applications further need to process sufficient samples, adding the high-content requirement to repeat the processes in multiple regions. Systems capable of performing such automated image-based localized photo-triggered processes are rare.

One example of processing proteins, lipids, or nucleic acids is to label them for isolation and identification. The labeled proteins, lipids, or nucleic acids can be isolated and identified using other systems such as a mass spectrometer or a sequencer. STOMP (spatially targeted optical microproteomics) technique proposed by Kevin C Hadley et al. in 2015 is a technique that is operated manually using a commercially available two-photon system, lacking the main elements to reach the high-content capability of this disclosure. The laser capture microdissection (LCM) system widely used to isolate a part of tissues or cell cultures using laser cutting does not have axial precision that this invention can achieve in addition to the lack of high-content capability.

### SUMMARY

A microscope-based illumination and imaging system comprising: a first light source; a first dichroic mirror adapted to reflect light from the first light source onto a sample; and a second light source adapted to transmit light onto the sample at one or more wavelengths in a second light source wavelength range having a lower limit equal to or greater than 250 nm and having an upper limit equal to or less than 470 nm through a tube lens of a microscope, through a second dichroic mirror, and through the first dichroic mirror, the second dichroic mirror adapted to reflect light from the sample.

In one aspect, the second dichroic mirror is highly transmissive in a second dichroic mirror transmissive wavelength band of at least the second light source wavelength range.

In one aspect, the second dichroic mirror transmissive wavelength band extends above and/or below the second light source wavelength range.

In one aspect, the second dichroic mirror is highly transmissive in a second dichroic mirror transmissive wavelength band having a lower limit equal to or greater than 250 nm and having an upper limit equal to or less than 470 nm.

In one aspect, the second dichroic mirror is highly reflective in a second dichroic mirror reflective wavelength band that does not overlap with the second dichroic mirror transmissive wavelength band.

In one aspect, the second dichroic mirror reflective wavelength band has a lower limit equal to or greater than 350 nm and an upper limit equal to or less than 900 nm.

In one aspect, the first dichroic mirror is highly transmissive in a first dichroic mirror transmissive wavelength band of at least the second light source wavelength range.

In one aspect, the first dichroic mirror transmissive wavelength band extends above and/or below the second light source wavelength range.

In one aspect, the first dichroic mirror is highly transmissive in a primary first dichroic mirror transmissive wavelength band having a lower limit equal to or greater than 250 nm and having an upper limit equal to or less than 470 nm.

In one aspect, the first dichroic mirror is highly transmissive in a secondary first dichroic mirror transmissive wavelength band (i) having a lower limit equal to or greater than 350 nm and having an upper limit equal to or less than 470 nm and (ii) not overlapping with the primary first dichroic mirror transmissive wavelength band.

In one aspect, the first dichroic mirror is highly transmissive in a secondary first dichroic mirror transmissive wavelength band (i) having a lower limit equal to or greater than 440 nm and having an upper limit equal to or less than 570 nm and (ii) not overlapping with the primary first dichroic mirror transmissive wavelength band.

In one aspect, the first dichroic mirror is highly transmissive in a secondary first dichroic mirror transmissive wavelength band (i) having a lower limit equal to or greater than 500 nm and having an upper limit equal to or less than 650 nm.

In one aspect, the first dichroic mirror is highly transmissive in a secondary first dichroic mirror transmissive wavelength band (i) having a lower limit equal to or greater than 600 nm and having an upper limit equal to or less than 750 nm.

In one aspect, the first dichroic mirror is highly transmissive in a secondary first dichroic mirror transmissive wavelength band (i) having a lower limit equal to or greater than 700 nm and having an upper limit equal to or less than 900 nm.

In one aspect, the first dichroic mirror is highly transmissive in multiple different non-overlapping transmissive wavelength bands each having a lower limit equal to or greater than 350 nm and having an upper limit equal to or less than 900 nm.

In one aspect, the first dichroic mirror is highly reflective in a first dichroic mirror reflective wavelength band (i) having a lower limit equal to or greater than 300 nm and having an upper limit equal to or less than 420 nm and (ii) not overlapping with the primary first dichroic mirror transmissive wavelength band.

In one aspect, the first dichroic mirror is highly reflective in a first dichroic mirror reflective wavelength band (i) having a lower limit equal to or greater than 430 nm and having an upper limit equal to or less than 530 nm and (ii) not overlapping with the primary first dichroic mirror transmissive wavelength band.

In one aspect, the first dichroic mirror is highly reflective in a first dichroic mirror reflective wavelength band having a lower limit equal to or greater than 480 nm and having an upper limit equal to or less than 570 nm.

In one aspect, the first dichroic mirror is highly reflective in a first dichroic mirror reflective wavelength band having a lower limit equal to or greater than 530 nm and having an upper limit equal to or less than 610 nm.

In one aspect, the first dichroic mirror is highly reflective in a first dichroic mirror reflective wavelength band having a lower limit equal to or greater than 610 nm and having an upper limit equal to or less than 670 nm.

In one aspect, the first dichroic mirror is highly reflective in a first dichroic mirror reflective wavelength band having a lower limit equal to or greater than 710 nm and having an upper limit equal to or less than 770 nm.

In one aspect, the first dichroic mirror is highly reflective in multiple different non-overlapping first dichroic mirror reflective wavelength bands each (i) having a lower limit equal to or greater than 350 nm and having an upper limit equal to or less than 900 nm, and (ii) not overlapping with the primary first dichroic mirror transmissive wavelength band.

In one aspect, the sample is disposed on a stage of the microscope.

In one aspect, the system further comprises a receiver adapted to receive light reflected by the second dichroic mirror.

In one aspect, the receiver is a camera.

A microscope-based illumination and imaging system is provided, comprising: a first light source; a first dichroic mirror adapted to reflect light from the first light source; a second dichroic mirror adapted to transmit the light from the first light source onto a sample; a second light source adapted to transmit light onto the sample at one or more wavelengths in a second light source wavelength range having a lower limit equal to or greater that 250 nm and having an upper limit equal to or less than 470 nm through a tube lens of a microscope, through the first dichroic mirror and through the second dichroic mirror, the second dichroic mirror adapted to reflect light from the sample.

In one aspect, the first dichroic mirror is highly transmissive in a first dichroic mirror transmissive wavelength band of at least the second light source wavelength range.

In one aspect, the first dichroic mirror transmissive wavelength band extends above and/or below the second light source wavelength range.

In one aspect, the first dichroic mirror is highly transmissive in a first dichroic mirror transmissive wavelength band having a lower limit equal to or greater than 250 nm and having an upper limit equal to or less than 470 nm.

In one aspect, the first dichroic mirror is highly reflective in a first dichroic mirror reflective wavelength band that does not overlap with the first dichroic mirror transmissive wavelength band.

In one aspect, the first dichroic mirror reflective wavelength band has a lower limit equal to or greater than 300 nm and an upper limit equal to or less than 900 nm.

In one aspect, the second dichroic mirror is highly transmissive in a second dichroic mirror transmissive wavelength band of at least the second light source wavelength range.

In one aspect, the second dichroic mirror transmissive wavelength band extends above and/or below the second light source wavelength range.

In one aspect, the second dichroic mirror is highly transmissive in a primary second dichroic mirror transmissive wavelength band having a lower limit equal to or greater than 250 nm and having an upper limit equal to or less than 530 nm.

In one aspect, the second dichroic mirror is highly transmissive in a secondary second dichroic mirror transmissive wavelength band (i) having a lower limit equal to or greater than 430 nm and having an upper limit equal to or less than 530 nm and (ii) not overlapping with the primary first dichroic mirror transmissive wavelength band.

In one aspect, the second dichroic mirror is highly transmissive in a secondary second dichroic mirror transmissive wavelength band having a lower limit equal to or greater than 480 nm and having an upper limit equal to or less than 570 nm.

In one aspect, the second dichroic mirror is highly transmissive in a secondary second dichroic mirror transmissive wavelength band having a lower limit equal to or greater than 530 nm and having an upper limit equal to or less than 610 nm.

In one aspect, the second dichroic mirror is highly transmissive in a secondary second dichroic mirror transmissive wavelength band having a lower limit equal to or greater than 610 nm and having an upper limit equal to or less than 670 nm.

In one aspect, the second dichroic mirror is highly transmissive in a secondary second dichroic mirror transmissive wavelength band having a lower limit equal to or greater than 710 nm and having an upper limit equal to or less than 770 nm.

In one aspect, the second dichroic mirror is highly transmissive in multiple different non-overlapping transmissive wavelength bands each having a lower limit equal to or greater than 400 nm and an upper limit equal to or less than 900 nm.

In one aspect, the second dichroic mirror is highly reflective in a second dichroic mirror reflective wavelength band (i) having a lower limit equal to or greater than 350 nm and having an upper limit equal to or less than 470 nm and (ii) not overlapping with the primary second dichroic mirror transmissive wavelength band.

In one aspect, the second dichroic mirror is highly reflective in a second dichroic mirror reflective wavelength band (i) having a lower limit equal to or greater than 440 nm and having an upper limit equal to or less than 570 nm and (ii) not overlapping with the primary second dichroic mirror transmissive wavelength band.

In one aspect, the second dichroic mirror is highly reflective in a second dichroic mirror reflective wavelength band having a lower limit equal to or greater than 500 nm and having an upper limit equal to or less than 650 nm.

In one aspect, the second dichroic mirror is highly reflective in a second dichroic mirror reflective wavelength band having a lower limit equal to or greater than 600 nm and having an upper limit equal to or less than 750 nm.

In one aspect, the second dichroic mirror is highly reflective in a second dichroic mirror reflective wavelength band having a lower limit equal to or greater than 700 nm and having an upper limit equal to or less than 900 nm.

In one aspect, the second dichroic mirror is highly reflective in multiple different non-overlapping second dichroic mirror reflective wavelength bands each (i) having a lower limit equal to or greater than 300 nm and an upper limit equal to or less than 900 nm, and (ii) not overlapping with the primary second dichroic mirror transmissive wavelength band.

In one aspect, the sample is disposed on a stage of the microscope.

In one aspect, the system includes a receiver adapted to receive light reflected by the second dichroic mirror.

In one aspect, the receiver is a camera.

A method is provided, comprising: projecting light from a first light source in a first light source wavelength to a first dichroic mirror to reflect the light onto a sample; passing light reflected or generated by the sample in response to the first light source through the first dichroic mirror to a second dichroic mirror to reflect the light to a receiver; projecting light from a second light source in a second light source wavelength range through the second dichroic mirror and through the first dichroic mirror onto the sample;

In one aspect, the first light source wavelength comprises a first light source wavelength range.

In one aspect, the first light source wavelength comprises approximately 488 nm.

In one aspect, the first light source wavelength comprises approximately 561 nm.

In one aspect, the first light source wavelength comprises approximately 635 nm.

In one aspect, the second light source wavelength range comprises approximately 250-470 nm.

In one aspect, the second light source wavelength range is adapted for excitation, photoactivation, photo-manipulation, or other photochemical processing of the sample.

In one aspect, the first dichroic mirror and second dichroic mirror are highly transmissive in the second light source wavelength range of the second light source.

In one aspect, the first dichroic mirror and second dichroic mirror transmit over 80% of light from the second light source.

In one aspect, the second dichroic mirror is highly reflective in a second dichroic mirror reflective wavelength band that does not overlap with a second dichroic mirror transmissive wavelength band.

In one aspect, the second dichroic mirror reflective wavelength band has a lower limit equal to or greater than 350 nm and an upper limit equal to or less than 900 nm.

In one aspect, the first dichroic mirror is highly transmissive in a first dichroic mirror transmissive wavelength band of at least the second light source wavelength range.

In one aspect, the receiver is a camera.

A method is provided, comprising: projecting light from a first light source in a first light source wavelength to a first dichroic mirror to reflect the light through a second dichroic mirror onto a sample; passing light reflected or generated by the sample in response to the first light source to the second dichroic mirror to reflect the light to a receiver; and projecting light from a second light source in a second light source wavelength range through the first dichroic mirror and through the second dichroic mirror onto the sample.

In one aspect, the first light source wavelength comprises a first light source wavelength range.

In one aspect, the first light source wavelength comprises approximately 488 nm. In one aspect, the first light source wavelength comprises approximately 561 nm.

In one aspect, the first light source wavelength comprises approximately 635 nm.

In one aspect, the second light source wavelength range comprises approximately 250-470 nm.

In one aspect, the second light source wavelength range is adapted for excitation, photoactivation, photo-manipulation, or other photochemical processing of the sample.

In one aspect, the first dichroic mirror and second dichroic mirror are highly transmissive in the second light source wavelength range of the second light source.

In one aspect, the first dichroic mirror and second dichroic mirror transmit over 80% of light from the second light source.

In one aspect, the receiver is a camera.

In one aspect, the systems and methods described herein do not include mechanical switches for switching light paths from the first or second light sources.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1 shows a microscope-based system for illuminating a sample on a stage for imaging and/or photoactivation of the sample.

FIG. 2 is a chart showing the transmission and reflection characteristics of the first dichroic mirror.

FIG. 3 is a chart showing the transmission and reflection characteristics of the second dichroic mirror.

FIG. 4 shows another embodiment of a microscope-based system for illuminating a sample on a stage for imaging and/or photoactivation of the sample.

FIG. 5 is a chart showing the transmission and reflection characteristics of the second dichroic mirror.

FIG. 6 is a chart showing the transmission and reflection characteristics of the first dichroic mirror.

### DETAILED DESCRIPTION

Microscope-based systems and a methods for image-guided microscopic illumination are provided. The microscope system can include a stage configured to be loaded with a sample. The microscope-based system may include a first light source, a second light source, a first dichroic mirror, a second dichroic mirror, and a receiver. The first and second dichroic mirrors can be highly transmissive in transmissive wavelength bands and highly reflective in reflective wavelength bands to selectively transmit/receive light from the first light sources to the sample and to the receiver for imaging samples, and allow transmit light from the second light source to the sample for photochemical processing at specific locations (pattern illumination) according to the imaging. The characteristic design of the two dichroic mirror systems allows multi-channel (wavelength) imaging and patten illumination that can be operated quickly without using mechanical switches for switching different light path for each individual function, so as to achieve the high efficiency of the image-guided microscopic illumination for photo-processing large amount of the biomolecules in the samples, which can increase the sensitivity of the result for the further analysis.

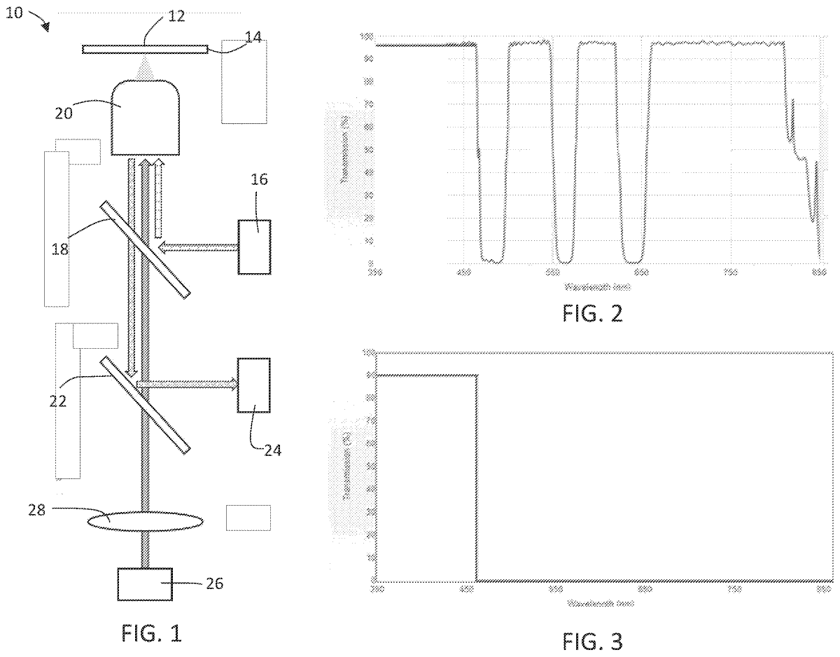

FIG. 1 shows a microscope-based system 10 for illuminating a sample 12 on a stage 14 for imaging and/or photoactivation of the sample. A first light source 16 projects light (at a wavelength of, e.g., 488 nm, 561 nm, or 635 nm) to a first dichroic mirror 18, which reflects the light through the microscope's objective 20 onto the sample 12. The signal from the sample (i.e., light reflected by or generated by the sample in response to light from light source 16) then passes through objective 20 and through first dichroic mirror 18 to a second dichroic mirror 22, which reflects the signal to an eyepiece, camera, or other receiver 24. Light from first light source 16 may be used for obtaining an image of the sample and/or for photoactivation of the sample.

System 10 also has a second light source 26 (at one or more wavelengths in a range of, e.g., 250-470 nm) for, e.g., excitation, photoactivation, photo-manipulation, or other photochemical processing of sample 12. Light source 26 transmits light to sample 12 through the microscope's tube lens 28, second dichroic mirror 22, first dichroic mirror 18, and the objective 20. The signal from the sample resulting from the illumination from light source 26 once again passes through objective 20 and through first dichroic mirror 18 to a second dichroic mirror 22, which reflects the signal to the eyepiece, camera, or other receiver 24.

FIG. 2 is a chart showing the transmission and reflection characteristics of the first dichroic mirror 18, and FIG. 3 is a chart showing the transmission and reflection characteristics of the second dichroic mirror 22. In order to transmit the light from light source 26, first dichroic mirror 18 and second dichroic mirror 22 are highly transmissive (i.e., transmitting over 80%, or over 90% of incident light) in a range of wavelengths at least equal to, and possibly extending above and/or below, the wavelength range of second light source 26. First dichroic mirror 18 is also highly transmissive in wavelengths corresponding to the expected images and signals from the sample (e.g., about 502.5-544.5 nm for imaging Alexa 488 or ATTO 488 or GFP or FITC or YFP in the sample, 582-617.5 nm for imaging Alexa 568 or Alexa 594 or ATTO 550 or ATTO 565 or ATTO 590, Cy3, or Cy3B or TRITC or RFP or mCherry or Texas Red in the sample, and 663-700 nm for imaging Alexa 647 or Cy5 in the sample) so that the images and/or signals from the sample can pass through the first dichroic mirror 18 to the second dichroic mirror 22, and it is highly reflective (i.e., reflects over 80%, or over 90% of the light) in wavelengths ranges including the wavelength(s) of first light source 16 (e.g., about 473-491 nm for imaging Alexa 488 or ATTO 488 or GFP or FITC or YFP in the sample, 559-568.2 nm for imaging Alexa 568 or Alexa 594 or ATTO 550 or ATTO 565 or ATTO 590, Cy3, or Cy3B or TRITC or RFP or mCherry or Texas Red in the sample, 632-647.1 nm for imaging Alexa 647 or Cy5 in the sample). Second dichroic mirror 22 is highly reflective at wavelengths of about 470-900 nm so that the signal from the sample (e.g., from imaging (fluorescence imaging, brightfield imaging, darkfield imaging, differential interference contrast imaging (DIC), phase contrast imaging) or from photoactivation (fluorescence, reflection, bleaching, spectral signals)) are directed to the eyepiece, camera, or other receiver 24.

In some embodiments, the details of the first dichroic mirror 18 and the second dichroic mirror 22 could be listed as Table 1.

TABLE 1

| | | | |
|---|---|---|---|
| Type of | wavelength | | |
| wavelength band | range | Purpose | Applications |

First Dichroic Mirror

| | | | | |
|---|---|---|---|---|
| Primary | 250-300 | nm | Transmit second light | To perform |
| Transmission | | | source (e.g., ~250 nm | photochemical |
| | | | or ~280 nm) | processing on the sample |
| Reflective | 310-410 | nm | Reflect the first light | To excite the sample |
| | | | source (e.g., ~365 nm | (e.g., DAPI or EBFP) |
| | | | or ~385 nm or ~405 nm) | for imaging |
| Secondary | 420-460 | nm | Transmit the signal to | To receive the emission |
| transmission | | | detector | from the sample (e.g., |
| | | | | DAPI or EBFP) for |
| | | | | imaging |
| Reflective | 470-492 | nm | Reflect the first light | To excite the sample |
| | | | source (470-492 nm) | (e.g., Alexa 488 or Atto |
| | | | | 488 or GFP or FITC) for |
| | | | | imaging |
| Secondary | 500-521 | nm | Transmit the signal to | To receive the emission |
| transmission | | | detector | from the sample (e.g., |
| | | | | Alexa 488 or Atto 488 or |
| | | | | GFP or FITC) for |
| | | | | imaging |
| Reflective | 525-537 | nm | Reflect the first light | To excite the sample |
| | | | source (525-537 nm) | (e.g., Alexa 532 or Alexa |
| | | | | 568 or ATTO 532 or |
| | | | | ATTO 550 or ATTO 565 |
| | | | | or Cy3, or Cy3B or |
| | | | | TRITC or RFP or |
| | | | | mCherry or Texas Red) |
| | | | | for imaging |
| Secondary | 544-618 | nm | Transmit the signal to | To receive the emission |
| transmission | | | detector | from the sample (e.g., |
| | | | | Alexa 532 or Alexa 568 |
| | | | | or ATTO 532 or ATTO |
| | | | | 550 or ATTO 565 or |
| | | | | Cy3, or Cy3B or TRITC |
| | | | | or RFP or mCherry or |
| | | | | Texas Red) for imaging |
| Reflective | 630-650 | nm | Reflect the first light | To excite the sample |
| | | | source (630-650 nm) | (e.g., Alexa 647 or Cy5) |
| | | | | for imaging |
| Secondary | 660-730 | nm | Transmit the signal to | To receive the emission |
| transmission | | | detector | from the sample (e.g., |
| | | | | Alexa 647 or Cy5) for |
| | | | | imaging |
| Reflective | 740-760 | nm | Reflect first light source | To excite the sample |
| | | | (740-760 nm) | (e.g., Alexa 750 or Cy5 |
| | | | | or DyLight 750 or ATTO |
| | | | | 740) for imaging |
| Secondary | 770-810 | nm | Transmit the signal to | To receive the emission |
| transmission | | | detector | from the sample (e.g., |
| | | | | Alexa 750 or Cy5 or |
| | | | | DyLight 750 or ATTO |
| | | | | 740) for imaging |

Second Dichroic Mirror

| | | | | |
|---|---|---|---|---|
| Transmission | 250-300 | nm | Transmit second light | To perform |
| | | | source (e.g., ~250 nm | photochemical |
| | | | or ~280 nm) | processing on the sample |
| Reflective | 400-900 | nm | Reflect all the signals to | To receive all the signals |
| | | | the detector | |

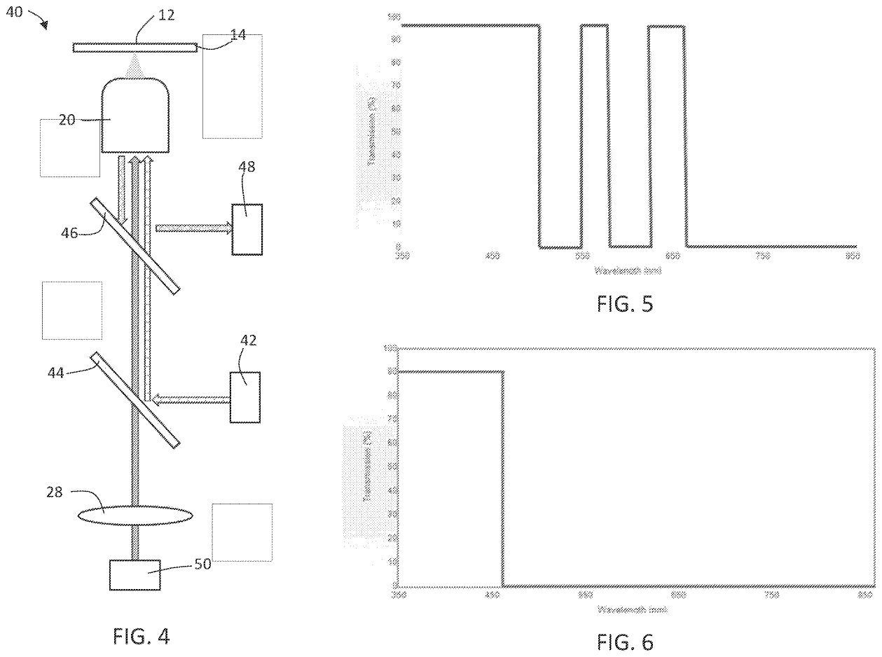

FIG. 4 shows another embodiment of a microscope-based system 40 for illuminating a sample 12 on a stage 14 for imaging and/or photoactivation of the sample. A first light source 42 projects light (at a wavelength of, e.g., 488 nm, 561 nm, or 635 nm) to a first dichroic mirror 44, which reflects and directs the light through a second dichroic mirror 46 and the microscope's objective 20 onto the sample 12. The signal from the sample (i.e., light reflected by or generated by the sample in response to light from light source 42) then passes through objective 20 and is reflected by second dichroic mirror 46 to an eyepiece, camera, or other receiver 48. Light from first light source 42 may be used for obtaining an image of the sample and/or for photoactivation of the sample.

System 40 also has a second light source 50 (at one or more wavelengths in a range of, e.g., 250-470 nm) for, e.g., excitation, photoactivation, photo-manipulation, or other photochemical processing of sample 12. Light source 50 transmits light to sample 12 through the microscope's tube lens 28, first dichroic mirror 44, second dichroic mirror 46, and the objective 20. The signal from the sample resulting from the illumination by light source 50 once again passes through objective 20 and is reflected by second dichroic mirror 46 to the eyepiece, camera, or other receiver 48.

FIG. 5 is a chart showing the transmission and reflection characteristics of the second dichroic mirror 46, and FIG. 6 is a chart showing the transmission and reflection characteristics of the first dichroic mirror 44. In order to transmit the light from light source 50, first dichroic mirror 44 and second dichroic mirror 46 are highly transmissive (i.e., transmitting over 80%, or over 90% of incident light) in a range of wavelengths at least equal to, and possibly extending above and/or below, the wavelength range of second light source 50. Second dichroic mirror 46 is also highly transmissive in wavelength ranges including the wavelength(s) of first light source 42 (e.g., about 473-491 nm for imaging Alexa 488 or ATTO 488 or GFP or FITC or YFP in the sample, 559-568.2 nm for imaging Alexa 568 or Alexa 594 or ATTO 550 or ATTO 565 or ATTO 590, Cy3, or Cy3B or TRITC or RFP or mCherry or Texas Red in the sample, 632-647.1 nm for imaging Alexa 647 or Cy5 in the sample), while first dichroic mirror is highly reflective in those wavelength ranges. Second dichroic mirror 46 is highly reflective in wavelengths corresponding to the expected images and signals from the sample (e.g., about 502.5-544.5 nm for imaging Alexa 488 or ATTO 488 or GFP or FITC or YFP in the sample, 582-617.5 nm for imaging Alexa 568 or Alexa 594 or ATTO 550 or ATTO 565 or ATTO 590, Cy3, or Cy3B or TRITC or RFP or mCherry or Texas Red in the sample and 663-700 nm for imaging Alexa 647 or Cy5 in the sample) so that the images and/or signals from the sample (e.g., from imaging (fluorescence imaging, brightfield imaging, darkfield imaging, differential interference contrast imaging (DIC), phase contrast imaging) or from photoactivation (fluorescence, reflection, bleaching, spectral signals)) are directed to the eyepiece, camera, or other receiver 48.

In some embodiments, the primary second dichroic mirror transmissive band in FIG. 5 is 350 nm-491 nm, which is above the wavelength range of the second light source (250-470 nm). In this embodiment, this primary second dichroic mirror transmissive band can be used for (1) transmitting the second light source (e.g., 360 nm or 405 nm) (2) transmitting the first light source (e.g., 473-491 nm) for exciting the Alexa 488 or Atto 488 or GFP or FITC in the sample, and its emission is in the range of the reflection band of second dichroic (502.5-544.5 nm).

In some embodiments, the details of the first dichroic mirror 44 and the second dichroic mirror 46 could be listed as Table 2.

TABLE 2

| | | | |
|---|---|---|---|
| Type of | wavelength | | |
| wavelength band | range | Purpose | Applications |

Second Dichroic Mirror

| | | | | |
|---|---|---|---|---|
| Primary | 250-410 | nm | (1) Transmit the | To perform photochemical |
| transmission | | | second light source | processing on the sample |
| | | | (e.g., ~250 nm | |
| | | | or ~280 nm) | |
| | | | (2) Transmit the | To excite the sample (e.g., |
| | | | first light source | DAPI or EBFP) for imaging |
| | | | (e.g., ~365 nm | |
| | | | or ~385 nm | |
| | | | or ~405 nm) | |
| Reflective | 420-460 | nm | Reflect the signal to | To receive the emission |
| | | | detector | from the sample (e.g., DAPI |
| | | | | or EBFP) for imaging |
| Secondary | 470-492 | nm | Transmit the first | To excite the sample (e.g., |
| transmission | | | light source (470- | Alexa 488 or Atto 488 or |
| | | | 492 nm) | GFP or FITC) for imaging |
| Reflective | 500-521 | nm | Reflect the signal to | To receive the emission |
| | | | detector | from the sample (e.g., Alexa |
| | | | | 488 or Atto 488 or GFP or |
| | | | | FITC) for imaging |
| Secondary | 525-537 | nm | Transmit the first | To excite the sample (e.g., |
| transmission | | | light source (525- | Alexa 532 or Alexa 568 or |
| | | | 537 nm) | ATTO 532 or ATTO 550 or |
| | | | | ATTO 565 or Cy3, or Cy3B |
| | | | | or mCherry or Texas Red) |
| | | | | for imaging |
| Reflective | 544-618 | nm | Reflect the signal to | To receive the emission |
| | | | detector | from the sample (e.g., Alexa |
| | | | | 532 or Alexa 568 or ATTO |
| | | | | 532 or ATTO 550 or ATTO |
| | | | | 565 or Cy3, or Cy3B or |
| | | | | TRITC or RFP or mCherry |
| | | | | or Texas Red) for imaging |
| Secondary | 630-650 | nm | Transmit the first | To excite the sample (e.g., |
| transmission | | | light source (630- | Alexa 647 or Cy5) for |
| | | | 650 nm) | imaging |
| Reflective | 660-730 | nm | Reflect the signal to | To receive the emission |
| | | | detector | from the sample (e.g., Alexa |
| | | | | 647 or Cy5) for imaging |
| Secondary | 740-760 | nm | Transmit the first | To excite the sample (e.g., |
| transmission | | | light source (740- | Alexa 750 or Cy5 or |
| | | | 760 nm) | DyLight 750 or ATTO 740) |
| | | | | for imaging |
| Reflective | 770-810 | nm | Reflect the signal to | To receive the emission |
| | | | detector | from the sample (e.g., Alexa |
| | | | | 750 or Cy5 or DyLight 750 |
| | | | | or ATTO 740) for imaging |

First Dichroic Mirror

| | | | | |
|---|---|---|---|---|
| Transmission | 250-300 | nm | Transmit the second | To perform photochemical |
| | | | light source | processing on the sample |
| | | | (e.g., ~250 nm | |
| | | | or ~280 nm) | |
| Reflective | 320-800 | nm | Reflect all the first | To excite the sample for |
| | | | light sources | imaging |

In some embodiments, the dichroic mirrors 22 and 46 are 24-26 mm by 34-37 mm by 1-2 mm with a nominal radius of curvature greater than or equal to 100 meters and a reflected wavefront error of less than 2λ P-V RWE.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1-73. (canceled)

74. A microscope-based illumination and imaging system, comprising:
a first light source;
a first dichroic mirror adapted to reflect light from the first light source onto a sample;
a second dichroic mirror adapted to reflect light from the sample to a camera; and
a second light source adapted to transmit light at a wavelength range from 250 nm to 470 nm through a tube lens of a microscope, through the second dichroic mirror, and through the first dichroic mirror onto the sample.

75. The system of claim 74, wherein the first dichroic mirror and the second dichroic mirror transmit at least over 80% of light from the second light source.

76. The system of claim 74, wherein the first dichroic mirror and the second dichroic mirror are highly transmissive in a primary transmissive wavelength band having a lower limit equal to or greater than 250 nm and having an upper limit equal to or less than 470 nm.

77. The system of claim 74, wherein the first light source is configured to project an exciting light onto the first dichroic mirror which reflects the exciting light onto the sample, and wherein the sample is configured to reflect or generate an emission light that passes through the first dichroic mirror and is reflected by the second dichroic mirror to the camera.

78. The system of claim 77, wherein the first dichroic mirror is highly transmissive in multiple different non-overlapping secondary transmissive wavelength bands each having a lower limit equal to or greater than 350 nm and having an upper limit equal to or less than 900 nm, and not overlapping with a first dichroic mirror primary transmissive wavelength band having a lower limit equal to or greater than 250 nm and having an upper limit equal to or less than 470 nm.

79. The system of claim 78, wherein the multiple different non-overlapping secondary transmissive wavelength bands have:
(i) a lower limit equal to or greater than 350 nm and an upper limit equal to or less than 470 nm;
(ii) a lower limit equal to or greater than 440 nm and an upper limit equal to or less than 570 nm;
(iii) a lower limit equal to or greater than 500 nm and an upper limit equal to or less than 650 nm;
(iv) a lower limit equal to or greater than 600 nm and an upper limit equal to or less than 750 nm; and
(v) a lower limit equal to or greater than 700 nm and an upper limit equal to or less than 900 nm.

80. The system of claim 77, wherein the first dichroic mirror is highly reflective in multiple different non-overlapping first dichroic mirror reflective wavelength bands each having a lower limit equal to or greater than 350 nm and having an upper limit equal to or less than 900 nm, and not overlapping with a primary first dichroic mirror transmissive wavelength band having a lower limit equal to or greater than 250 nm and having an upper limit equal to or less than 470 nm.

81. The system of claim 80, wherein the multiple different non-overlapping first dichroic mirror reflective wavelength bands have:
(i) a lower limit equal to or greater than 300 nm and an upper limit equal to or less than 420 nm;
(ii) a lower limit equal to or greater than 430 nm and an upper limit equal to or less than 530 nm;
(iii) a lower limit equal to or greater than 480 nm and an upper limit equal to or less than 570 nm;
(iv) a lower limit equal to or greater than 530 nm and an upper limit equal to or less than 610 nm;
(v) a lower limit equal to or greater than 610 nm and an upper limit equal to or less than 670 nm; and
(vi) a lower limit equal to or greater than 710 nm and an upper limit equal to or less than 770 nm.

82. The system of claim 74, wherein the second dichroic mirror is highly reflective in a second dichroic mirror reflective wavelength band that does not overlap with a second dichroic mirror transmissive wavelength band having a lower limit equal to or greater than 250 nm and having an upper limit equal to or less than 470 nm.

83. The system of claim 82, wherein the second dichroic mirror reflective wavelength band has a lower limit equal to or greater than 350 nm and an upper limit equal to or less than 900 nm.

84. The system of claim 74, wherein the first light source is configured to project an exciting light onto the first dichroic mirror which reflects the exciting light, the exciting light reflected by the first dichroic mirror passing through the second dichroic mirror onto the sample, and wherein the sample is configured to reflect or generate an emission light that is reflected by the second dichroic mirror to the camera.

85. The system of claim 84, wherein the first dichroic mirror is highly reflective in a first dichroic mirror reflective wavelength band that does not overlap with a primary dichroic mirror transmissive wavelength band having a lower limit equal to or greater than 250 nm and having an upper limit equal to or less than 470 nm.

86. The system of claim 85, wherein the first dichroic mirror reflective wavelength band has a lower limit equal to or greater than 300 nm and an upper limit equal to or less than 900 nm.

87. The system of claim 84, wherein the second dichroic mirror is highly transmissive in multiple different non-overlapping secondary transmissive wavelength bands, each having a lower limit equal to or greater than 400 nm and an upper limit equal to or less than 900 nm, and not overlapping with a second dichroic mirror primary transmissive wavelength band having a lower limit equal to or greater than 610 nm and having an upper limit equal to or less than 670 nm.

88. The system of claim 87, wherein the multiple different non-overlapping secondary transmissive wavelength bands have:
(i) a lower limit equal to or greater than 430 nm and an upper limit equal to or less than 530 nm;
(ii) a lower limit equal to or greater than 480 nm and an upper limit equal to or less than 570 nm;
(iii) a lower limit equal to or greater than 530 nm and an upper limit equal to or less than 610 nm;
(iv) a lower limit equal to or greater than 610 nm and an upper limit equal to or less than 670 nm; and
(v) a lower limit equal to or greater than 710 nm and an upper limit equal to or less than 770 nm.

89. The system of claim 84, wherein the second dichroic mirror is highly reflective in multiple different non-overlapping second dichroic mirror reflective wavelength bands each having a lower limit equal to or greater than 300 nm and an upper limit equal to or less than 900 nm, and not overlapping with a second dichroic mirror primary transmissive wavelength band having a lower limit equal to or greater than 610 nm and having an upper limit equal to or less than 670 nm.

90. The system of claim 89, the multiple different non-overlapping second dichroic mirror reflective wavelength bands having:
(i) a lower limit equal to or greater than 350 nm and an upper limit equal to or less than 470 nm;
(ii) a lower limit equal to or greater than 440 nm and an upper limit equal to or less than 570 nm;
(iii) a lower limit equal to or greater than 500 nm and an upper limit equal to or less than 650 nm;
(iv) a lower limit equal to or greater than 600 nm and an upper limit equal to or less than 750 nm; and
(v) a lower limit equal to or greater than 700 nm and an upper limit equal to or less than 900 nm.

91. The system of claim 74, wherein the second light source wavelength range is adapted for excitation, photoactivation, photo-manipulation, or other photochemical processing of the sample.

92. The system of claim 74, wherein the system does not include mechanical switches for switching light paths form the first or second light sources.

93. A photolabeling method, comprising:
projecting light from a first light source in a first light source wavelength to a first dichroic mirror to reflect the light onto a sample;
passing light reflected or generated by the sample in response to the first light source through the first dichroic mirror to a second dichroic mirror to reflect the light to a receiver; and
projecting light from a second light source in a second light source wavelength range through the second dichroic mirror and through the first dichroic mirror onto the sample.

94. A photolabeling method, comprising:
projecting light from a first light source in a first light source wavelength to a first dichroic mirror to reflect the light through a second dichroic mirror onto a sample;
passing light reflected or generated by the sample in response to the first light source to the second dichroic mirror to reflect the light to a receiver; and
projecting light from a second light source in a second light source wavelength range through the first dichroic mirror and through the second dichroic mirror onto the sample.
